(19) United States
(12) Patent Application Publication
(10) Pub. No.: US 2026/0195533 A1
(43) Pub. Date: Jul. 9, 2026

(54) TARGETED LANGUAGE TRANSFORMATION FOR RANDOM CONTRAST LEARNING

(71) Applicant: Lumina AI, LLC, Tampa, FL (US)

(72) Inventors: Fadi G. Farhat, New York, NY (US); Morten Middelfart, Tampa, FL (US); Benjamin A. Martin, Tampa, FL (US)

(73) Assignee: Lumina AI, LLC, Tampa, FL (US)

(21) Appl. No.: 19/441,807

(22) Filed: Jan. 6, 2026

Related U.S. Application Data
(60) Provisional application No. 63/742,798, filed on Jan. 7, 2025.

(51) Int. Cl. G06F 40/284; G06F 40/47; G06N 20/00

(52) U.S. Cl. CPC G06F 40/284; G06F 40/47; G06N 20/00

(57) ABSTRACT

Systems and methods in accordance with the present disclosure can structure text data for use in efficient machine learning operations, such as for random contrast learning (RCL). The text data can be tokenized and converted back into text for machine learning, and can be selectively transformed to mitigate machine-reading errors associated with an operating system to be used for storing or reading the text data, or for performing machine learning using the text data.

### CROSS-REFERENCE TO RELATED APPLICATION

The present application claims the benefit of priority of U.S. Provisional Patent Application No. 63/742,798, filed Jan. 7, 2025. The contents of this provisional application are incorporated herein by reference in their entirety.

### BACKGROUND

The present application relates generally to the field of training machine learning models for language processing, and more particularly to targeted language transformation for random contrast learning.

In a variety of training processes, machine learning models can be provided with text (or image, etc.) data to be used as training examples. For example, machine learning models can be trained to learn a mapping between input text and output text of the training examples. The performance of a computing system that executes the training process can be affected by the structuring of the training examples.

### SUMMARY

Systems and methods in accordance with the present disclosure can process text data for training models for language processing in a manner that prevents errors associated with machine reading and/or storage of the text data. This can allow for the text to be structured in a format effective for storage by given operating systems and/or for use in machine learning tasks, including for random contrast learning (RCL) operations.

At least one aspect relates to a method. The method can include one or more of loading, by one or more processors, one or more libraries to execute a machine learning task; importing, by the one or more processors, a tokenizer; configuring, by the one or more processors, an input sequence length; retrieving, by the one or more processors, a file comprising text data for the machine learning task; filtering, by the one or more processors, extraneous text from the file to generate filtered text data; tokenizing the filtered text data based at least on the input sequence length to generate a vocabulary corresponding to the filtered text data; generating a plurality of training data samples, by applying a sliding window process to the filtered text data, each training data sample comprising a plurality of tokens and a target token, the target token indicative of a class to which the plurality of tokens belong; generating indices corresponding to the vocabulary; converting the training data samples from tokens to text to generate text data samples; performing character replacement on the text data samples to modify one or more characters according to an operating system; performing word replacement on the text data samples according to the operating system; shortening words of the text data samples that exceed a length threshold; labeling a case of one or more words of the text data samples according to a case sensitivity of the operating system; and storing the text data samples as a first set of identifiers of words of the text data samples corresponding to the target tokens and a second set of word values representing the plurality of tokens mapped to the first set of identifiers.

At least one aspect relates to a method. The method can include one or more of generating, by one or more processors, from text data according to an order of the text data, a plurality of data samples, each data sample comprising a sequence of input tokens and a target token indicative of a class to which the sequence belongs, each input token of the sequence of input tokens and the target token comprising an index mapped to a corresponding word in a vocabulary of words representing the text data; converting, by the one or more processors, the sequence of input tokens and the target token from the index to a corresponding word in the vocabulary to which the index is mapped, to generate a plurality of text samples; transforming, by the one or more processors, the plurality of text samples according to one or more characteristics of a target operating system operated by the one or more processors; and generating, by the one or more processors, a training data structure comprising a plurality of folders each representing a given target token of the plurality of text samples and being assigned each input token of the plurality of text samples that belongs to the class of the given target token.

At least one aspect relates to a system that includes one or more processors. The one or more processors can perform any of various operations described herein.

At least one aspect relates to a non-transitory computer-readable medium that can include machine-executable instructions that when executed by one or more processors, cause the one or more processors to perform any of various operations described herein.

These and other aspects and implementations are discussed in detail below. The foregoing information and the following detailed description include illustrative examples of various aspects and implementations and provide an overview or framework for understanding the nature and character of the claimed aspects and implementations.

### BRIEF DESCRIPTION OF THE DRAWINGS

FIG. 1 depicts an example of a system to perform targeted language transformation for random contrast learning, in accordance with one or more implementations described herein.

FIG. 2 depicts an example of a method of targeted language transformation for random contrast learning, in accordance with one or more implementations described herein.

FIG. 3 depicts an example of a computing system to perform any of various operations described herein.

FIG. 4 depicts an example of a staging pipeline, in accordance with one or more implementations described herein.

FIG. 5 depicts an example of a method for generating a training data structure, in accordance with one or more implementations described herein.

### DETAILED DESCRIPTION

Before turning to the figures, which illustrate the exemplary implementations in detail, it should be understood that the present disclosure is not limited to the details or methodology set forth in the description or illustrated in the figures. It should also be understood that the terminology used herein is for the purpose of description only and should not be regarded as limiting.

Some machine learning models and/or language models (for example and without limitation, large language models (LLMs), small language models (SLMs)) are trained in a manner that can depend on the format and/or structure of the data, e.g., text data, that is used for training. This can apply to random contrast learning (RCL)-based models, which can be structured to allow for training with reduced compute power and/or data storage requirements, among other benefits.

However, a critical factor in the effectiveness of training of machine learning models, and thus the performance of the trained models for performing inference tasks such as data generation or classification, is the quality of the data used for training. The quality of the data can correspond to various characteristics, including but not limited to the accuracy of mapping of example inputs and example outputs (e.g., in supervised learning-type training techniques and/or classification tasks), the inclusion or exclusion of particular characters or words during preprocessing, and/or instances in which certain text may be machine-readable in a manner that may cause errors, bugs, or other unintended responses by the computing system that is processing the text for the training process.

In some implementations, RCL models can be useful due to their ability to be trained and/or run at inference without the use of massive computing resources (or with significantly increased speed and/or efficiency with such resources), as is typical for transformer-based LLMs. This can include, for example, operating RCL models on target systems, such as Windows-based systems. Systems and methods in accordance with the present disclosure can structure training data in a manner useful for the target systems, such as to allow for more efficient data retrieval, and/or allow for less error-prone storage and retrieval of text from initial text data files.

Systems and methods in accordance with the present disclosure can facilitate more effective training of machine learning models by performing a targeted sequence of data preparation and staging that can prevent various errors in such training processes. This can include, for example and without limitation, filtering initial text data and/or tokenized text data in a manner that removes words or characters that can trigger errors without losing fidelity of the resulting filtered text data relative to the initial text data, and storing the data samples to be used for training in a manner that accounts for machine-reading characteristics of the system (e.g., operating system; in some implementations, this may also correspond to a type of hardware to be used to operate on the data) on which the training process is to be executed. Various such operations can allow for the training process to be performed without large cloud-based and/or data center-based computing systems (which can allow for reduced compute, power, and/or network communications or latency, as well as improved security, for the training process), and/or to result in a better performing machine learning model. Systems and methods in accordance with the present disclosure can configure training data samples for random contrast learning, such as to store data samples more effectively in a non-tokenized format.

Systems and methods in accordance with the present disclosure can include a staging pipeline that transforms raw text into a structured, standardized format that can be used for random contrast learning. The transformed data can be compatible across various operating systems through systematic reversible transformations, such as, for example, character normalization and UTF-8 name mapping. These systematic reversible transformations can maintain semantic fidelity by leveraging standardized Unicode naming to consistently represent characters, preserving character meaning and contextual integrity across different operating systems. Moreover, the staging pipeline can transform data using techniques such as reserved word escaping, length adjustments for identifiers, and encoding marks to prevent errors relating to data failing to meet operating system constraints (e.g., maintaining case sensitivity). These transformations (e.g., reserved word escaping, length adjustments for identifiers, and encoding marks) can further optimize the text for classification tasks. Additionally, the staging pipeline can include a vectorized knowledge seam that implements deterministic hashing and join matrices to convert tokens into unique numeric identifiers. By implementing deterministic hashing and join matrices, the vectorized knowledge seam can allow the staging pipeline to execute precise and reliable data transformations while enhancing model accuracy. These techniques can allow the staging pipeline to incorporate training insights during inference operations, conserving computing resources and improving prediction accuracy by integrating contextually relevant data into inference outcomes.

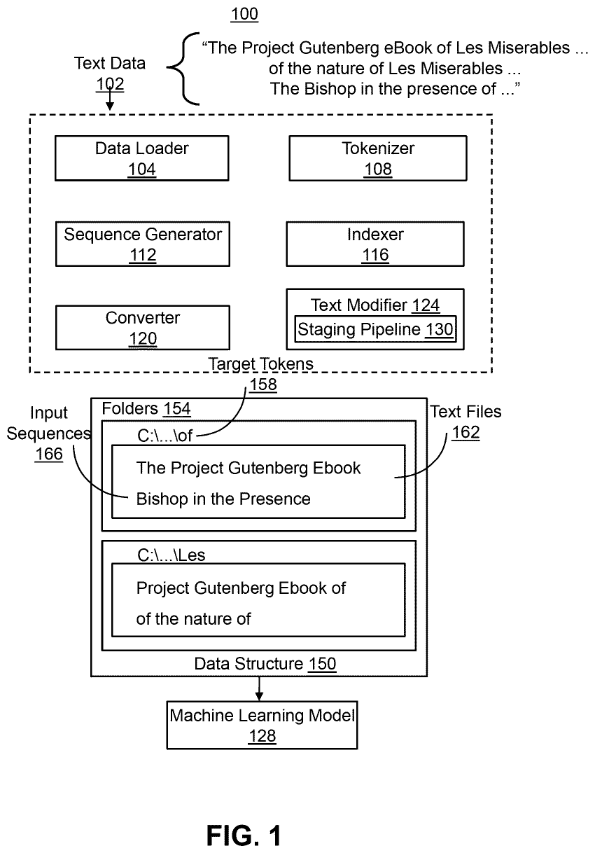

FIG. 1 depicts an example of a system 100. The system 100 can be used to perform targeted language transformation for random contrast learning. For example, the system 100 can be used to prepare and/or stage data samples (e.g., text data samples), in a format targeted to characteristics (e.g., properties, requirements, text processing methods, machine reading methods) of the system 100 and to inputting into a machine learning model to be trained using random contrast learning. Various components of the system 100 and/or coupled with the system 100, such as the data loader 104, tokenizer 108, sequence generator 112, indexer 116, converter 120, text modifier 124, and/or machine learning model 128 can be implemented using any one or more functions, algorithms, rules, heuristics, scripts, code, machine learning models, or various combinations thereof.

The system 100 can include a data loader 104. The data loader 104 can load (e.g., and without limitation, into an operating system, application, or development environment) data, libraries, and/or functions to be used for structuring data for performing RCL, e.g., on machine learning model 128. For example, the data loader 104 can import tokenizer 108. As another example, the data loader 104 can import text data 102.

The text data 102 can include one or more data structures (e.g., files), that represent text. For example, the text data 102 can include a text data file representing text that has an order, such as a document (e.g., book, letter, article, etc.). The text data 102 can be in plain text; for example, the data loader 104 can receive the text data 102 in a plain text format. In some implementations, the data loader 104 can convert formatted or markup text data (e.g., HTML, XML, JSON, etc.) to plain text.

In some implementations, the data loader 104 performs preprocessing on the text data 102. For example, the data loader 104 can parse the text data 102 to detect characters or words that may not be useful for the RCL process, such as extraneous or long words (e.g., words having greater than 12 characters, having greater than 15 characters, etc.) and/or non-language characters (e.g., control characters, non-readable characters). As an example, control characters can include newline characters (e.g., “\n”), tab (e.g., “\t”), carriage return (e.g., “\r”), or null character (e.g., “\0”). Control characters can include characters or combinations of characters that can control how text will be processed rather than how that text will be displayed. As another example, non-readable characters can include backspace (e.g., “\b”), bell (e.g., “\a”), or escape (e.g., “\x1B”). Non-readable characters and other control codes can be non-displayed symbols in the text, functioning for processing of data.

The tokenizer 108 can tokenize the text data 102. For example, the tokenizer 108 can generate a plurality of tokens that correspond to elements of the text data 102, such as to words represented by the text data 102. The elements (e.g., words, numbers, events, etc.) can include natural language words and numeric characters as well as non-alphanumeric characters, such as punctuation, brackets, and parentheses, for example. The tokenizer 108 can include any of various components that can parse text to select words from text, and can assign numerical identifiers to the selected words. The tokenizer 108 can include, for example and without limitation, a regular expression tokenizer.

The tokenizer 108 can generate the plurality of tokens to map each element of the text data 102 to a corresponding unique identifier, such as a unique numerical value for each token and/or element. The tokenizer 108 can store the tokens (e.g., the elements corresponding to the tokens), as a vocabulary (and/or dictionary) and/or update the vocabulary to include the tokens. For example, the vocabulary can be a set of unique words (or tokens) from any one or more text data 102 processed by the system 100.

The system 100 can include a sequence generator 112. The sequence generator 112 can generate one or more sequences of the tokens. Each sequence can include a plurality of tokens, such as for the sequence to represent an input, and the sequence generator 112 can associate the sequence with a target token. The sequence generator 112 can generate the sequences according to an input sequence length. The sequence generator 112 can select the input sequence length responsive to receiving a user input representing the input sequence length, retrieving the input sequence length from memory, or configuring the input sequence length according to factor(s) such as number of words of the text data 102 and/or the vocabulary, accuracy or optimization of sequence generation or RCL model training, etc. The input sequence length can be two tokens or greater.

The target token can be a token that is subsequent to the tokens of the sequence (e.g., relative to an order of words of the text data 102). In some implementations, the sequence generator 112 selects the tokens of a given sequence to be a set of sequential (e.g., immediately sequence) tokens corresponding to the input sequence length, and selects the target token to be the token immediately subsequent to the last token of the sequence. This can allow the system 100 to represent the sequences as data samples that belong to the class represented by the target token.

For example, the sequence generator 112 can generate the sequences and target tokens by applying a sliding window mechanism to processing of the text data 102, e.g., to a stream of text represented by the text data 102. For example, given the stream of text, the sequence generator 112 can first start at the first token of the text data 102, and can count a number of tokens corresponding to the input sequence length. The sequence generator 112 can assign the counted tokens to a first sequence, and can select the token following the counted tokens as the target token for the first sequence. The sequence generator 112 can shift to the second token of the text data 102 to be the first token of a second sequence, can count the number of tokens corresponding to the input sequence length, can assign the counted tokens to the second sequence (the counted tokens thus including the target token of selected for the first sequence), and can select the token following the counted tokens as the target token for the second sequence. The sequence generator 112 can iteratively repeat the process of generating sequences and selecting for/assigning target tokens to the sequences up to an end point, including, for example, an end of the stream of text.

For example, given an input sequence length of four words and/or tokens, and a text stream of “The Project Gutenberg eBook of Les Miserables.”, the sequence generator 112 can generate the input sequences and corresponding target tokens as shown in Table 1 below:

TABLE 1
Sequences generated from text “The Project
Gutenberg eBook of Les Miserables.”

| Input | | | | | |
|---|---|---|---|---|---|
| Sequence | | | | | Target |
| Index | Token 1 | Token 2 | Token 3 | Token 4 | Token |
| 1 | The | Project | Gutenberg | eBook | of |
| 2 | Project | Gutenberg | eBook | of | Les |
| 3 | Gutenberg | eBook | of | Les | Miserables |
| 4 | eBook | of | Les | Miserables | . |

Referring further to FIG. 1, the system 100 can include an indexer 116. The indexer 116 can generate a list of indices corresponding to the words in the vocabulary. For example, the indexer 116 can generate the list of indices to represent a list of unique words and their corresponding index numbers.

For example, given a vocabulary of [The, Project, Gutenberg, eBook, of, Les, Miserables,.], the indexer 116 can generate indices [1, 2, 3, 4, 5, 6, 7, 8]. It will be appreciated that the generated indices may have any of various numbering schemes, such as to not be sequential and/or may be based the tokenizer used and/or on previously determined indices given previously processed text; for example and without limitation, the indices for “The Project Gutenberg eBook of” may be [6202, 5216, 3066, 13100, 19270].

Referring further to FIG. 1, the system 100 can include a converter 120. The converter 120 can convert the input sequences and target tokens to text to prepare the text for formatting and/or use for RCL, such as to allow for text-based RCL training for the machine learning model, rather than training in an encoded or compressed space. For example, the converter 120 can retrieve a given input sequence of tokens and target token, and parse the list of indices to retrieve the corresponding words that are associated with the input sequences of tokens and target tokens to generate converted text.

For example, given an input sequence of [1, 2, 3, 4] and a target token [5], the converter 120 can generate a converted input sequence [The, Project, Gutenberg, eBook] and target token [of].

The system 100 can include a text modifier 124. The text modifier 124 can perform various operations to apply character replacements or modifications to various characters of the converted (to text) input sequences and target tokens, such as to prevent errors or bugs that may occur from machine reading of such characters. In some implementations, text modifier 124 can include a staging pipeline 130. Staging pipeline 130 can execute one or more systematic reversible transformations. For example, the text modifier 124 (e.g., using staging pipeline 130) can modify a given character according to a type of the given character. In some implementations, the text modifier 124 (e.g., using one or more layers of staging pipeline 130) can modify characters of non-alphanumeric type(s), and can determine to not modify characters of alphanumeric types (e.g., [0 to 9], [a to z], [A to Z]). In some implementations, the text modifier 124 performs modifications based at least on a character encoding mode of the system 100 (e.g., UTF-8, etc.) or an operating system to be used for performing RCL (e.g., Windows vs. Unix and/or Linux-based operating systems, etc.).

For example, the text modifier 124 (e.g., using one or more layers of staging pipeline 130) can retrieve a text representation of non-alphanumeric characters, and can replace the non-alphanumeric characters with the text representation. In some implementations, the text modifier 124 assigns a wrapper character to modified characters, such as exclamation points at a start and end of the text representation, to indicate the transformation. For example, the text modifier 124 can modify an opening bracket, ‘[’, to ‘!squarebracketopen!’. The text modifier 124 can modify a closing bracket, ‘]’, to !squarebracketclosed!′.

In some implementations, the text modifier 124 (e.g., using one or more layers of staging pipeline 130) modifies tokens according to a word list that can trigger errors for the operating system in which data for RCL training is to be stored. For example, the text modifier 124 can assign the wrapper characters to reserved words that may not be permitted for data storage operations by the operating system, such as AUX, CON, or PRN; e.g., can modify ‘AUX’ to ‘!AUX!’, ‘CON’ to ‘CON!’, ‘PRN’ to ‘!PRN’, etc. The text modifier 124 can select the word list based at least on the operating system.

In some implementations, the text modifier 124 (e.g., using one or more layers of staging pipeline 130) can modify tokens to reduce the length of tokens, such as to avoid excess characters in token characters strings that may cause errors in generation of folders or other data structures. For example, the Windows operating system has a default limit of 260 characters for path length (e.g., a threshold for the path length), which can cause errors if a total length of a folder path for folders (which, as described further below, are used to represent target tokens) exceeds the path length limit. For example, the text modifier 124 can perform replacements such as ‘greeksmallletter’ to ‘gsl’, ‘greekcapitalletter’ to ‘gcl’, ‘latinsmallletter’ to ‘Isl’, and ‘latincapitalletter’ to ‘lcl’.

In some implementations, the text modifier 124 (e.g., using one or more layers of staging pipeline 130) performs character case labeling, e.g., according to the operating system and/or one or more rules for case sensitivity for the operating system. For example, where the operating system is not case-sensitive (e.g., the operating system lacks case sensitivity), the text modifier 124 can apply transforms to indicate character cases, which can allow the system 100 to differentiate tokens having the same characters in different cases (e.g., differentiate ‘RcL’ from ‘RCL’). For example, the text modifier 124 can prepend a transform ‘!upper!’ to upper-case letters for operating systems that are not case-sensitive, e.g., to transform ‘RCL’ to ‘!upper!R!upper! C!upper!L’; to transform ‘Prism’ to ‘!upper!Prism’.

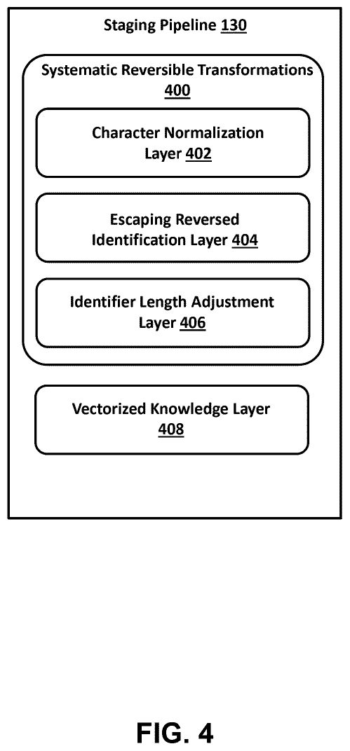

Additional details regarding the staging pipeline 130 and the text modifier 124 are described below with reference to FIG. 4.

Referring further to FIG. 1, the system 100 can store the input sequences and target tokens (e.g., responsive to operations performed by the sequence generator 112, indexer 116, converter 120, and/or text modifier 124) in a data structure and/or format to facilitate RCL, including to facilitate performing RCL using text, rather than encodings. For example, as depicted in FIG. 1, a data structure 150 can include folders 154 representing target tokens 158 and text files 162 representing input sequences 166 that belong to the classes of the target tokens 158. The system 100 can generate blank target token (class) folders; if an error occurs during folder generation, the system 100 can store the candidate path in a failed list for later evaluation. The system 100 can interrupt the folder generation process, in some implementations, to present a user interface for correcting errors. Responsive to generation of the folders 154, the system 100 can generate the text files 162 to represent the input sequences 166 that correspond to the target tokens 158. In some implementations, the system 100 updates previously generated or stored folders 154 and/or text files 162. The items of data structure 150 may have transforms applied as well in the representations in the text of data structure 150.

Referring further to FIG. 1, the system 100 can apply the data of the data structure 150 to train or update one or more machine learning models 128, such as to perform RCL for the machine learning models 128. The one or more machine learning models 128 can be implemented by a system remote from the system 100 and communicatively coupled with the system 100 (or, in some implementations, can be at least partially implemented by the system 100 or a device or operating system that includes the system 100). In some implementations, the system 100 performs the RCL for any one or more of training, updating, or fine-tuning the one or more machine learning models 128.

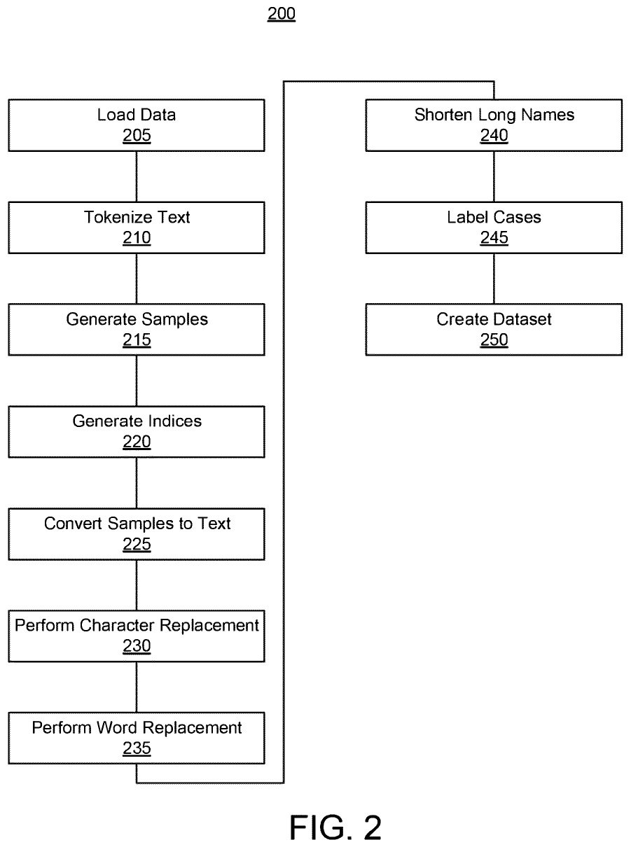

FIG. 2 depicts an example of a method 200 of configuring data for RCL. The method 200 can be performed using any one or more systems or devices described herein, including but not limited to the system 100 or one or more components thereof. Various operations of the method 200 can be performed sequentially, in parallel, and/or in batch operations, including for sequential or batch processing of multiple text files.

At 205, data to be configured for RCL can be loaded. For example, a text data file having text from which to generate tokens for language processing can be retrieved. Any of various files, libraries, tools, and/or applications, e.g., tokenizers, can be retrieved. The text data of the text data file can be preprocessed or cleaned, e.g., to remove control characters and/or non-readable characters.

At 210, the text data can be tokenized. Tokenizing the text data can include mapping each word of the text data to a corresponding unique numerical value. Tokenizing the text data can include generating or updating a vocabulary to indicate the words and corresponding unique numerical values.

At 215, initial data samples can be generated from the text data. For example, a stream of text data can be parsed, e.g., sequentially, to identify sequences of tokens and/or words and corresponding target tokens that follow the sequences. A given (initial) data sample can include a sequence of tokens (e.g., “The Project Gutenberg eBook”) of an input sequence length and a corresponding target token (e.g., “of”) that follows the tokens of the sequence. A sliding window mechanism can be performed to iteratively generate sequences of tokens and target tokens. The generation of the initial data samples can relate the sequences of tokens to the target tokens such that the target tokens represent classes (and/or categories) to which the respective sequences belong.

At 220, a list of indices corresponding to the words in the vocabulary can be generated. The list can represent the unique words of the vocabulary and the corresponding unique numerical values of the words, e.g., as generated by the tokenizer.

At 225, the initial data samples are converted from tokenized values to text. For example, using the list of indices, text data samples having words can be generated from the token-formatted data samples, such as to modify an input sequence [6202, 5216, 3066, 13100] and target token to an input sequence [The, Project, Gutenberg, eBook] and target token [of].

At 230, character replacements can be performed on the text data samples. This can include removing or replacing characters that may trigger machine reading or processing errors, such as based on an operating system to be used to store the data and/or perform RCL. For example, non-alphanumeric characters can be replaced or transformed, such as to be prepended and/or appended with transform characters to prevent character processing issues.

At 235, word replacements can be performed on the text data samples. This can include transforming or modifying characters or words that are reserved by the operating system, such as words that may trigger errors if used for folder names or other data structures or operations.

At 240, word shortening can be performed, e.g., on words of the target tokens, to reduce potential sizes of folder paths of folders to be generated to represent the target tokens. For example, long transform names can be shortened to reduce the number of characters in the transform names.

At 245, case labeling and/or transformation of data samples can be performed, such as where the operating system is not case-sensitive (e.g., the operating system lacks case sensitivity). For example, an indicator of a case of a character can be assigned, e.g., prepended, to the text.

At 250, the (modified) data samples can be stored for use for RCL, such as to create a dataset of target tokens and associated input sequences. For example, folders can be generated to represent the text of target tokens. Data files, e.g., text files, can be stored in each folder to indicate the sequences that belong to the classes of the target tokens.

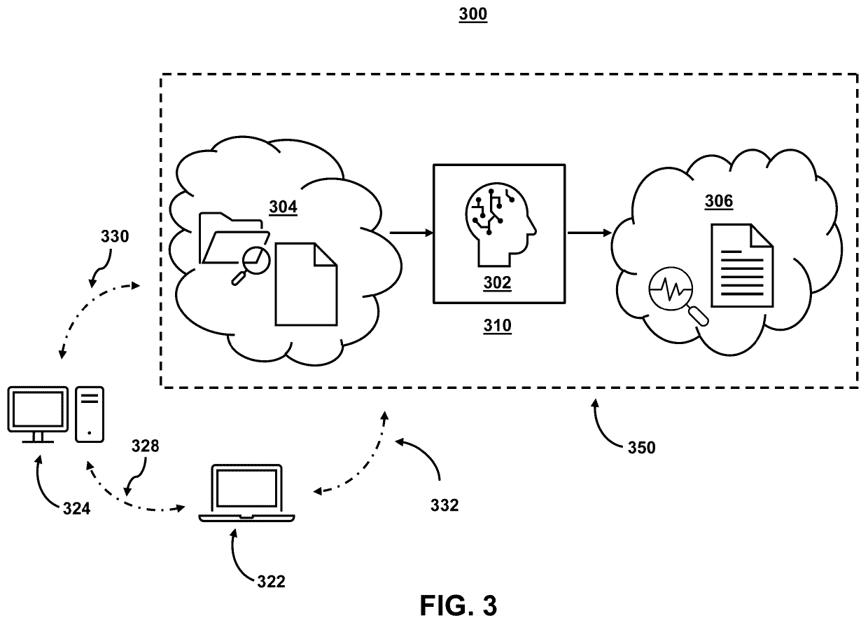

FIG. 3 depicts an example of a system 300, e.g., a computing system, which can be used to perform various operations described herein. For example, the system 300 can be used to perform any of various operations described with reference to the system 100 of FIG. 1 and/or method 200 of FIG. 2. Model 302 can be used to deploy one or more components of machine learning model 128, such as with data 304 and/or for generation of outputs 306.

As shown in FIG. 3, system 300 may include mobile device 322 and user terminal 324. Any one or more components of the system 100 of FIG. 1 may be implemented using one or more of mobile device 322 and/or user terminal 324, as well as other devices, systems, services, etc. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices.

FIG. 3 also includes cloud components 310. Cloud components 310 may alternatively be any computing device as described above, and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted that, while one or more operations are described herein as being performed by particular components of system 300, these operations may, in some implementations, be performed by other components of system 300. As an example, while one or more operations are described herein as being performed by components of mobile device 322, these operations may, in some implementations, be performed by components of cloud components 310. In some implementations, the various computers and systems described herein may include one or more computing devices that are programmed to perform the described functions. Additionally, or alternatively, multiple users may interact with system 300 and/or one or more components of system 300. For example, in one implementation, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data.

Additionally, as mobile device 322 and user terminal 324 are shown as touchscreen smartphones, these displays also act as user input interfaces. It should be noted that in some implementations, the devices may have neither user input interfaces nor displays and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to a desired task or set of tasks.

Each of these devices may also include electronic storage. The electronic storage may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices. Cloud components 310 may include one or more components of system 100 of FIG. 1. Cloud components 310 may access one or more databases. In some examples, cloud components 310 may access a cloud-based memory.

System 300 also includes API layer 350. API layer 350 may allow the system to generate summaries across different devices. In some implementations, API layer 350 may be implemented on mobile device 322 or user terminal 324. Alternatively, or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some implementations, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some implementations, the system architecture may use an open API approach. In such cases, API layer 350 may use commercial or open source API Platforms and their modules. API layer 350 may use a developer portal. API layer 350 may use strong security constraints applying WAF and DDoS protection, and API layer 350 may use RESTful APIs as standard for external integration.

FIG. 4 is an illustrative diagram of staging pipeline 130 of FIG. 1, in accordance with one or more implementations. Text data (e.g., text data 102 of FIG. 1) can be input to staging pipeline 130 to transform it into a structured and standardized format conducive for machine learning tasks (i.e., classification tasks). For example, the transformed data (e.g., transformed by staging pipeline 130) can be input to machine learning model 128 of FIG. 1. Staging pipeline 130 can generate the transformed version of text data 102 such that it is compatible across multiple operating systems. Moreover, the transformed version of text data 102 generated by staging pipeline 130 can preserve semantic integrity, enabling the transformations to be reversible. Although staging pipeline 130 includes layers for character normalization, escaping reserved words, adjusting identifier lengths, and maintaining case sensitivity, additional or fewer layers can be included to perform additional or fewer transformers to the input data (e.g., text data 102).

Staging pipeline 130 can include layers for various systematic reversible transformations 400. For example, staging pipeline 130 can include a character normalization layer 402, an escaping reversed identification layer 404, and an identifier length adjustment layer 406. Staging pipeline 130 can also include a labeling layer, or other layers, or combinations thereof. The data (e.g., text data 102) input to staging pipeline 130 can be input to some or all of the layers (i.e., some or all of character normalization layer 402, escaping reserved identification layer 404, identifier length adjustment layer 406). The data can be input to those layers in parallel, sequentially, or both. For instance, one or more layers of staging pipeline 130 can use the outputs of other layers as their inputs. As an example, identifier length adjustment layer 406 can take, as input, an output from initial character normalization layer 402.

Staging pipeline 130 can provide data compatibility and consistency across different operating systems by implementing transformations (e.g., systematic reversible transformations 400) based on filesystem-specific requirements. By transforming data consistent with the filesystem-specific requirements, staging pipeline 130 can process input data (e.g., text data 102) seamlessly, irrespective of the underlying operating system. Staging pipeline 130 can achieve this compatibility and consistency by selecting and providing some or all of the input data to one or more layers associated with systematic reversible transformations 400. Some example systematic reversible transformations include, but are not limited to, character normalization transformations to standardize character representations, which can be executed using character normalization layer 402, escaping reserved identifier transformations to resolve naming conflicts, which can be executed using escaping reserved identification layer 404, and adjusting identifier length transformations to meet filesystem path constraints, which can be executed using identifier length adjustment layer. Each of these operations can account for conventions and limitations of different operating systems. By leveraging standardized Unicode naming and executing all transformations in a reversible manner, staging pipeline 130 can preserve semantic integrity of the original data form, enhancing data uniformly, mitigating errors, and ensuring data stability and reliability as the data passes through varying operational environments.

Staging pipeline 130 can maintain semantic fidelity by leveraging standardized Unicode naming to consistently represent characters, preserving character meaning and contextual integrity across different operating systems. Semantic fidelity refers to retaining the original meaning and context of text data throughout transformation processes. By leveraging standardized Unicode naming, staging pipeline 130 can assign each character and symbol across different languages a unique name and code point. For example, if the text data includes a character “é” in French text, the standardized Unicode naming implemented by staging pipeline 130 can assign a unique name (e.g., “LATIN SMALL LETTER E WITH ACUTE”) and a specific code point (e.g., “U+00E9”). The assigned unique name and code point can ensure that characters and symbols are consistently represented and interpreted to maintain uniformity across different systems and platforms. Staging pipeline 130 can minimize misinterpretations or data corruption due to character misreads or unsupported characters (i.e., unsupported by an operating system's native encoding techniques) by executing the Unicode naming standardization.

By implementing one or more functions as described above and/or further herein, the staging pipeline 130 can ensure that each layer processes text in a systematic and/or reproducible manner to produce consistent results for identical inputs. As a result of this deterministic nature, staging pipeline 130 can consistently process data to predictably generate reliable output. By improving predictability, staging pipeline 130 can contribute to improved model training and data analysis where the models have improved accuracy and reliability. Staging pipeline 130 can effectuate the systematic reproducibility through one or more of its layers, such as character normalization layer 402, escaping reserved identification layer 404, and identifier length adjustment layer 406. Character normalization layer 402, escaping reserved identification layer 404, and identifier length adjustment layer 406 can process each character or token using a same set of predefined transformations, minimizing output variability introduced by manual or ad hoc processing. Staging pipeline 130 can also facilitate deterministic outputs by using standardized Unicode naming for character representation, as mentioned above. For example, by encoding each character in a uniform manner across different systems, staging pipeline 130 can minimize discrepancies that can arise due to platform-specific encoding variations. Additionally, staging pipeline 130 can apply systematic reversible transformations, such as using wrapper markers and prepending case labels, to preserve the original structure and meaning of text. For example, if the input text includes the word “Data” and the character “&”, staging pipeline 130 can apply one or more systematic reversible transformations 400 to ensure that the transformed data is compatible and preserve meaning with respect to the original data. As an example, staging pipeline 130 can prepend a case label to the word “Data,” transforming it into “!upper!Data” to indicate that the initial letter is uppercase, while the ampersand “&” can be replaced with a wrapper marker, resulting in “!AMPERSAND!” as its standardized representation. As these transformations are reversible (e.g., the original text can be reconstructed if needed), staging pipeline 130 can ensure that system 100 of FIG. 1 maintains the integrity and clarity of the input data (e.g., text data 102) across operating systems and processing environments. Additionally, by facilitating deterministic outputs, staging pipeline 130 can maintain data integrity for developing robust machine learning models where consistent training data produces more reliable and accurate models.

Staging pipeline 130 can also include a vectorized knowledge layer 408 configured to enhance performance and accuracy of machine learning models (e.g., machine learning model 128 of FIG. 1). Vectorized knowledge layer 408 can execute deterministic hashing and join matrices to systematically converts tokens and/or extracted features into unique numeric identifiers, ensuring deterministic outputs (i.e., ensuring that similar input strings consistently yield the same numeric results, such as a 64-bit number). Deterministic hashing refers to a technique where the same input produces the same hash value, allowing data to be consistently matched or looked up. A join matrix refers to a structured table or grid to represent and evaluate relationships between datasets. The join matrix can indicate how rows from one table correspond to rows in another during a join operation.

Vectorized knowledge layer 408 can generate tables and matrices for robust model training and inference processes that produce reliable and reproducible outcomes from identical data inputs. Moreover, as a result of the inherent precision of hashing, vectorized knowledge layer 408 can support efficient data retrieval and integration in addition to reducing variability. Vectorized knowledge layer 408 can incorporate metadata replay using hashed IDs to retain and reapply learned insights during inference operating. For example, vectorized knowledge layer 408 can store, in memory, training information, such as context scores or feature influence metrics, alongside their hashed identifiers. During inference, the model (e.g., machine learning model 128) can use the hashed IDs to distinguish attribute contributions from specific features, allowing prior knowledge to be integrated into the prediction, improving recall capabilities by re-utilizing stored knowledge without the need for re-computation, optimizing computing resources, inferential accuracy, and contextual understanding.

Character normalization layer 402 can prepare text data (e.g., text data 102) for machine learning tasks by standardizing the text data format. The text data format in its standardized form can be compatible across different operating systems. Character normalization layer 402 can operate by transforming non-alphanumeric characters into standardized representations having a format compatible with the target operating system's requirements. For example, in some operating systems, because using the character “<” in file or folder names can cause errors, character normalization layer 402 can replace the character “<” with a standardized text representation, such as “!less_than!”, which conforms to the target operating system's requirements. Characterization normalization layer 402 can receive sequences of input tokens and target tokens derived from text samples (e.g., text data 102). Character normalization layer 402 can output a set of text samples. The set of text samples can include text samples where non-alphanumeric characters are uniformly replaced to standardize the text for subsequent data processing. Different target operating systems can have different characteristics that describe the properties, requirements, and constraints that can impact how data is processed by the character normalization layer 402. Some example characteristics of target operating system can include file system limitations (e.g., a 260-character path limit), reserved words and identifiers (e.g., “CON”, “AUX”, “PRN”), case sensitivity (e.g., transforming “Data” to “!upper!Data”), character encoding and normalization (e.g., transforming “<” to “!less_than!”), operating system compatibility (e.g., reversible operations), or other characteristics that illustrate how staging pipeline 130 can adapt data preparation and storage techniques to the target operating system's characteristics.

As an example, character normalization layer 402 can receive a text sample. Character normalization layer 402 can detect whether the text sample includes any special characters. For example, normalization layer 402 can detect that the text sample includes “< >&” and can transform these characters into standardized textual representations like, such as “<”, “>”, and “&”. These transformations can prevent interpretation issues or errors during data storage or processing in diverse environments, preserve the semantic meaning of the text, and enhance data integrity and accessibility across different operating platforms.

Escaping reversed identification layer 404 can be configured to modify reserved words and identifiers that may conflict with operating system conventions. By preventing conflicts with different operating system conventions, escaping reversed identification layer 404 can enhance data compatibility and integrity across operating systems. Escaping reversed identification layer 404 can detect whether a text sample includes any reserved words or system-sensitive identifiers. If so, escaping reversed identification layer 404 can transform those reserved words/system-sensitive identifiers by adding predefined escape characters. The predefined escape characters can circumvent conflicts during data storage and processing. Escaping reversed identification layer 404 can receive, as input, a sequence of text samples including tokens and target tokens. For example, the text data (e.g., text data 102) received by escaping reversed identification layer 404 can include reserved words and generate transformed text samples. Escaping reversed identification layer 404 can modify these reserved words to prevent operating system-specific errors. Some example operating system reserved words can include system-level programming words, such as “CON”, “AUX”, “if”, “else”, “while”, “fork”, “exec”, and “return”. Some example operating system reserved identifiers can include process IDs (PIDs), user IDs, file names, device names (e.g., “sda”, “tty”), or environment variables, such as “PATH”.

As an illustrative example, the text sample (e.g., text data 102) may include a reserved word, such as “CON” or “AUX”. These words may not be permissible as file names in certain operating systems. Escaping reversed identification layer 404 can modify these words by adding special characters or wrappers, for example “!CON!” or “!AUX!”, to ensure that the target filesystem handles these words correctly. In addition to preventing errors, escaping reserved identification layer 404 can adjust detected reserved words to maintain the seamless flow of data within staging pipeline 130, avoiding potential disruptions during data storage and retrieval processes. By adjusting the detected reserved words, escaping reversed identification layer 404 can enhance the robustness and reliability of text-to-classification training across different operating systems.

Identifier length adjustment layer 406 can be configured to check identifiers, such as names used for files, variables, or tokens, and confirm that those identifiers conform to length constraints imposed by filesystem specifications, such as those of the target operating system. Some examples of filesystem character length specifications include, but are not limited to, a maximum filename length of 255 characters, a maximum path length of about 260 characters in some operating systems, and limits on volume label lengths, such as 32 characters limits for NTFS and 11 characters for FAT32. Identifier length adjustment layer 406, implemented using text modifier 124 of FIG. 1, can scan each identifier within the text samples (e.g., of text data 102) to determine whether any text samples exceed a predetermined length threshold. Text samples that exceed the predetermined length threshold can result in filesystem path errors or storage incompatibilities.

Identifier length adjustment layer 406 can be configured to modify an identifier found to be too long by truncating or abbreviating the identifier while retaining the identifier's uniqueness and relevance so as to maintain compatibility across different systems. Identifier length adjustment layer 406 can receive, as input, the sequence of text samples including identifiers that may need adjustment due to their length, and can output transformed versions of the samples that conform to length requirements to ensure seamless storage and access on the target operating system.

As an example, identifier length adjustment layer 406 can detect a token in the input text (e.g., text data 102) having a name that exceeds character limit thresholds of a first (e.g., Windows operating system) file path. Some example character thresholds can include limiting name lengths to 260 characters. If the identifier is an important variable name or a descriptive class name, identifier length adjustment layer 406 can truncate the identifier and/or apply abbreviations to the identifier to modify the identifier to fit within the allowable character limit thresholds.

Staging pipeline 130 can additionally be configured to modify the text data (e.g., text data 102) when a case sensitivity of text data fails to align with a target operating system's rules. The case of each word in the text samples (e.g., text data 102) can be evaluated using staging pipeline 130, and the text samples can be tagged or transformed to preserve case distinctions (i.e., uppercase and lowercase distinctions) or adjust them to conform to match the filesystem's requirements. As an example, in an operating system that is not inherently case-sensitive (e.g., operating systems lacking case sensitivity), staging pipeline 130 can prepend or append specific markers to words in a text sample to preserve case distinctions when the data is stored or processed. For example, the word “Data” in some computing environments can be treated identically as “data”, potentially causing confusion or misclassification. Staging pipeline 130 can adjust these examples by marking them as “!upper!Data” and “!lower!data” to ensure their case differences are maintained throughout subsequent processes.

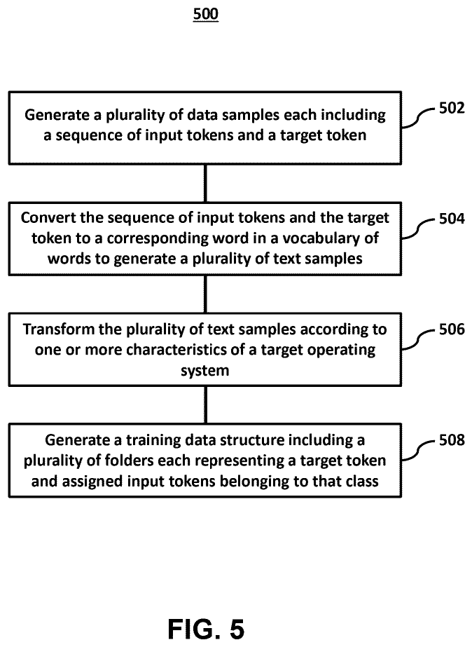

FIG. 5 depicts an example of a method 500 for generating a training data structure, in accordance with one or more embodiments described herein. Method 500 can be performed using any one or more systems or devices described herein, including but not limited to the system 100 or system 300 or one or more components thereof. Various operations of the method 500 can be performed sequentially, in parallel, and/or in batch operations, including for sequential or batch processing of multiple text files.

At 502, a plurality of data samples can be generated. The plurality of data samples can be generated from text data according to an order of the text data. Each data sample can include a sequence of input tokens and a target token. The target token can indicate a class to which the sequence of input tokens belongs. Each input token of the sequence of input tokens and the target token can include an index mapped to a corresponding word in a vocabulary of words representing the text data. In some implementations, sequence generator 112 of FIG. 1 can be used to generate the plurality of data samples. As an example, if the input text were “The quick brown fox jumps over the lazy dog,” generating data samples according to an order of the text can include creating a vocabulary and mapping each word and symbol to a unique index. For instance, “The” can be mapped to [1], “quick” to [2], “brown” to [3], and so on. Using a sliding window approach with a sequence length of four, the first data sample can include input tokens “The,” “quick,” “brown,” and “fox,” corresponding to indices [1, 2, 3, 4], and the target token “jumps” can be mapped to index [5]. The next data sample can shift the window by one word, resulting in the input tokens “quick,” “brown,” “fox,” and “jumps” with indices [2, 3, 4, 5], and the target token “over,” mapped to index [6]. Each data sample can include a sequence of input tokens and a target token, with all tokens represented by their respective indices in the vocabulary, supporting efficient processing and classification during model training.

Prior to generating the plurality of data samples, the text data can be filtered. The filtering of the text data can remove at least one control character from the text data. For example, a control character refers to a non-printing character in text data that can be used to control how text is processed or displayed, rather than being represented as a visible symbol. As an example, the newline character “\n” can refer to a control character that instructs an operating system to move to a new line when displaying text. In some implementations, data loader 104 can be configured to remove control characters from text data.

Generating the plurality of data samples can include tokenizing the text data. The tokenization of the text data can be performed, for example, using a tokenizer (e.g., tokenizer 108). The tokenization can generate the vocabulary of words.

Generating the plurality of data samples can include applying a sliding window mechanism to the text data. The sliding window mechanism can have an input sequence length. Applying the sliding window mechanism to the text data can generate sequences of input tokens and subsequent target tokens. In some implementations, sequence generation 112 can generate the data samples.

At 504, the sequence of input tokens and the target token can be converted from the index to a corresponding word in the vocabulary to which the index is mapped to generate a plurality of text samples. In some implementations, converter 120 can be configured to convert the sequence of input tokens and the target token from the index into the corresponding word in the vocabulary. Continuing a previous example, if the input indices are [1, 2, 3, 4] and the target index is 5, converter 120 can map words (e.g., “The,” “quick,” “brown,” “fox”) as input tokens and other words (e.g., “jumps”) as the target token.

At 506, the plurality of text samples can be transformed according to one or more characteristics of a target operating system. Transforming the text samples can include the text samples into a staging pipeline. The staging pipeline can generate a plurality of transformed samples based on the plurality of text samples. Each transformed sample can have a standardized format compatible with the target operating system. Characteristics of the target operating system can influence how data is processed by the character normalization layer (e.g., character normalization layer 402). For example, file system limitations, such as a 260-character path length limit, can necessitate data pipeline 130 shortening an identifier to avoid errors. Other characteristics of the target operating system to be addressed by staging pipeline 130 include reserved words modifications to escape characters, case sensitivity modifications to preserve case distinctions (e.g., for operating systems that are not case-sensitive), character encoding and normalization to convert special characters into standardized representations, and reversible operations to ensure compatibility with different operating systems. These adaptations enable the staging pipeline to reliably prepare and store text data in accordance with the characteristics of the target operating system. In some implementations, text modifier 124 of FIG. 1 can include staging pipeline 130.

The staging pipeline (e.g., staging pipeline 130) can include a character normalization layer. For example, as seen with respect to FIG. 4, staging pipeline 130 can include character normalization layer 402. Character normalization layer 402 can transform the plurality of text samples by executing a character normalization operation. The character normalization operation can include replacing non-alphanumeric characters with representations of the standardized format (e.g., the standardized format compatible with the target operating system).

The staging pipeline (e.g., staging pipeline 130) can include an escaping reversed identification layer. For example, as seen with respect to FIG. 4, staging pipeline 130 can include an escaping reversed identification layer 404. Escaping reversed identification layer 404 can transform by modifying one or more reserved words and identifiers at the escaping reversed identification layer of the staging pipeline. The reserved words and identifiers can correspond to one or more words and/or identifiers that conflict with the target operating system. Escaping revered identification layer 404 can modify the samples by adding at least one predefined escape character. For example, if the text sample contains the reserved word “CON,” escaping reserved identification layer 404 can modify it to “!CON!” by adding exclamation marks as predefined escape characters.

The staging pipeline (e.g., staging pipeline 130) can include an identifier length adjustment layer. For example, as seen with respect to FIG. 4, staging pipeline 130 can include an identifier length adjustment layer 406. Identifier length adjustment layer 406 can transform the plurality of text samples by modifying a length of an identified determined to exceed a predetermined length threshold at the identifier length adjustment layer of the staging pipeline. The predetermined length threshold can indicate an identifier length compatible with one or more filesystem path length limitations of the target operating system.

The staging pipeline (e.g., staging pipeline 130) can include a vectorized knowledge layer. For example, as seen with respect to FIG. 4, staging pipeline 130 can include a vectorized knowledge layer 408. Vectorized knowledge layer 408 can apply deterministic hashing, join matrices, or other operations, to convert one or more tokens of a text sample of one or more of the input text samples into a unique numeric identifier. For example, the text sample “!upper!Data!AMPERSAND! analytics,” can include tokens “!upper!Data”, “!AMPERSAND!”, and “analytics”, vectorized knowledge layer 408 can apply deterministic hashing to each token so that the same input string yields the same unique numeric identifier (e.g., a 64-bit number), producing IDs such as 873421905112334501 for!upper!Data, 402187663019887210 for! AMPERSAND!, and 991230045671223984 for analytics. Using a join matrix, vectorized knowledge layer 408 can relate these hashed identifiers within the sample (e.g., associating!AMPERSAND! as a connection between!upper!Data and analytics) to enable efficient lookups and integration during training and inference.

Transforming the plurality of text samples can include labeling a case of one or more words of one or more text samples of the plurality of text samples by the staging pipeline (e.g., staging pipeline 130). In some implementations, text modifier 124 can be configured to use staging pipeline 130 to align the case of the one or more words with one or more case sensitivity rules of the target operating system.

Transforming the plurality of text samples can include executing systematic reversible transformations to the text samples. The systematic reversible transformations can replace non-alphanumeric characters with standardized textual representations. Wrapper markers, prepend labels, or other techniques, can be used by staging pipeline 130 to preserve case distinction for operating systems that are not case sensitive.

At 508, a training data structure can be generated. The training data structure can include a plurality of folders each representing a given target token of the plurality of text samples and being assigned each input token of the plurality of text samples that belongs to the class of the given target token. For example, the training data structure that is generated can correspond to data structure 150 of FIG. 1. In some implementations, system 100 of FIG. 1 can employ different components to generate data structure 150. For example, sequence generate 112, indexer 116, converter 120, and text modifier 124 (including staging pipeline 130) can be used to generate aspects of data structure 150.

The training data structure (e.g., data structure 150) can include a hierarchical folder structure. Generating the training data structure can include storing, in each folder of the plurality of folders of the training data structure, one or more text files. The text files can include input sequences assigned to the class of the target token of that folder. The hierarchical folder structure refers to an organizational strategy to manage and store data samples generated during the transformation process within staging pipeline 130. Each folder can correspond to a unique target token that represents a specific class determined by the text data's classification tasks. Within each folder, text files can be stored that include sequences of input tokens associated with the class of the target token. As an example, the hierarchical folder structure can include top-level folders labeled with document types (e.g., “Invoice,” “Letter,” or “Report”). Within one of those document type label folders (e.g., the “Invoice” folder), multiple text files can be stored. Each Text file can include a set of token sequences belonging to that class (e.g., invoice class), which can be identified by the unique target tokens.

Method 500 can include at least one or more of the following steps being executed. For example, method 500 can include loading one or more libraries to execute a machine learning task; importing a tokenizer; configuring an input sequence length; retrieving a file comprising text data for the machine learning task; filtering extraneous text from the file to generate filtered text data; tokenizing the filtered text data based at least on the input sequence length to generate a vocabulary corresponding to the filtered text data; generating a plurality of training data samples, by applying a sliding window process to the filtered text data, each training data sample comprising a plurality of tokens and a target token, the target token indicative of a class to which the plurality of tokens belong; generating indices corresponding to the vocabulary; converting the plurality of training data samples from tokens to text to generate text data samples; performing character replacement on the text data samples to modify one or more characters according to a characteristic of an operating system; performing word replacement on the text data samples according to the operating system; shortening words of the text data samples that exceed a length threshold; modifying a case of one or more words of the text data samples according to a case sensitivity of the operating system; or storing the text data samples as a first set of identifiers of words of the text data samples corresponding to the target token and a second set of word values representing the plurality of tokens mapped to the first set of identifiers.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the implementations disclosed herein can be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor can be a microprocessor, or, any conventional processor, controller, microcontroller, soc (system on chip), som (system on module) or state machine. A processor also can be implemented as a combination of computing devices, such as a combination of a DSP and a microprocessor, a plurality of microprocessors, one or more microprocessors in conjunction with a DSP core, or any other such configuration. In some implementations, particular processes and methods can be performed by circuitry that is specific to a given function. The memory (e.g., memory, memory unit, storage device, etc.) can include one or more devices (e.g., RAM, ROM, Flash memory, hard disk storage, etc.) for storing data and/or computer code for completing or facilitating the various respective processes, layers and modules described in the present disclosure. The memory can be or include volatile memory or non-volatile memory, and can include database components, object code components, script components, or any other type of information structure for supporting the various activities and information structures described in the present disclosure. According to an exemplary implementation, the memory is communicably connected to the processor via a processing circuit and includes computer code for executing (e.g., by the processing circuit and/or the processor) the one or more processes described herein.

The present disclosure contemplates methods, systems and programming products on any machine-readable media for accomplishing various operations. The implementations of the present disclosure can be implemented using existing computer processors, or by a special purpose computer processor for an appropriate system, incorporated for this or another purpose, or by a hardwired system. Implementations within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or implementation, and references to “an implementation,” “some implementations,” “one implementation” or the like are not necessarily mutually exclusive and are intended to indicate that a particular feature, structure, or characteristic described in connection with the implementation can be included in at least one implementation or implementation. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein can be embodied in other specific forms without departing from the characteristics thereof. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining can be stationary (e.g., permanent or fixed) or moveable (e.g., removable or releasable). Such joining can be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling can be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements can differ according to other exemplary implementations, and such variations are intended to be encompassed by the present disclosure.

What is claimed is:

1. A method, comprising:
generating, by one or more processors, from text data according to an order of the text data, a plurality of data samples, each data sample comprising a sequence of input tokens and a target token indicative of a class to which the sequence of input tokens belongs, each input token of the sequence of input tokens and the target token comprising an index mapped to a corresponding word in a vocabulary of words representing the text data;
converting, by the one or more processors, the sequence of input tokens and the target token from the index to a corresponding word in the vocabulary to which the index is mapped, to generate a plurality of text samples;
transforming, by the one or more processors, the plurality of text samples according to one or more characteristics of a target operating system operated by the one or more processors; and
generating, by the one or more processors, a training data structure comprising a plurality of folders each representing a given target token of the plurality of text samples and being assigned each input token of the plurality of text samples that belongs to the class of the given target token.

2. The method of claim 1, wherein transforming the plurality of text samples comprises:
inputting the plurality of text samples into a staging pipeline to generate a plurality of transformed samples having a standardized format compatible with the target operating system.

3. The method of claim 2, wherein transforming the plurality of text samples comprises:
executing a character normalization operation to replace non-alphanumeric characters with representations of the standardized format.

4. The method of claim 2, wherein transforming the plurality of text samples comprises:
modifying one or more reserved words and identifiers conflicting with the target operating system by adding at least one predefined escape character.

5. The method of claim 2, wherein transforming the plurality of text samples comprises:
modifying a length of an identifier identified to exceed a predetermined length threshold for compatibility with one or more filesystem path length limitations of the target operating system.

6. The method of claim 2, wherein transforming the plurality of text samples comprises:
applying at least one of deterministic hashing or join matrices to convert one or more tokens of a text sample of the plurality of text samples into a unique numeric identifier.

7. The method of claim 2, wherein transforming the plurality of text samples comprises:
labeling a case of one or more words of at least one text sample of the plurality of text samples to align with one or more case sensitivity rules of the target operating system.

8. The method of claim 2, wherein the training data structure comprises a hierarchical folder structure, generating the training data structure comprises:
storing, in each folder of the plurality of folders, one or more text files comprising input sequences assigned to the class of the target token of the folder.

9. The method of claim 2, further comprising:
prior to generating the plurality of data samples, filtering the text data to remove at least one control character.

10. The method of claim 1, wherein generating the plurality of data samples comprises:
tokenizing the text data with a tokenizer to generate the vocabulary of words.

11. The method of claim 1, wherein generating the plurality of data samples comprises:
applying a sliding window mechanism having an input sequence length to generate sequences of input tokens and subsequent target tokens.

12. The method of claim 1, wherein transforming the plurality of text samples comprises:
replacing one or more non-alphanumeric characters with standardized textual representations using wrapper markers; and
prepending case labels to letters to preserve case distinctions on operating systems lacking case sensitivity.

13. The method of claim 1, further comprising:
at least one of:
loading one or more libraries to execute a machine learning task;
importing, by the one or more processors, a tokenizer;
configuring, by the one or more processors, an input sequence length;
retrieving, by the one or more processors, a file comprising text data for the machine learning task;
filtering, by the one or more processors, extraneous text from the file to generate filtered text data;
tokenizing the filtered text data based at least on the input sequence length to generate a vocabulary corresponding to the filtered text data;
generating a plurality of training data samples, by applying a sliding window process to the filtered text data, each training data sample comprising a plurality of tokens and a target token, the target token indicative of a class to which the plurality of tokens belong;
generating indices corresponding to the vocabulary;
converting the plurality of training data samples from tokens to text to generate text data samples;
performing character replacement on the text data samples to modify one or more characters according to a characteristic of an operating system;
performing word replacement on the text data samples according to the operating system;
shortening words of the text data samples that exceed a length threshold;
modifying a case of one or more words of the text data samples according to a case sensitivity of the operating system; or
storing the text data samples as a first set of identifiers of words of the text data samples corresponding to the target token and a second set of word values representing the plurality of tokens mapped to the first set of identifiers.

14. A system, comprising:
memory storing computer program instructions; and
one or more processors configured using the computer program instructions to:
generate, from text data according to an order of the text data, a plurality of data samples, each data sample comprising a sequence of input tokens and a target token indicative of a class to which the sequence of input tokens belongs, each input token of the sequence of input tokens and the target token comprising an index mapped to a corresponding word in a vocabulary of words representing the text data;
convert the sequence of input tokens and the target token from the index to a corresponding word in the vocabulary to which the index is mapped, to generate a plurality of text samples;
transform the plurality of text samples according to one or more characteristics of a target operating system operated by the one or more processors; and
generate a training data structure comprising a plurality of folders each representing a given target token of the plurality of text samples and being assigned each input token of the plurality of text samples that belongs to the class of the given target token.

15. The system of claim 14, wherein the computer program instructions comprising transforming the plurality of text samples configure the one or more processors to:
input the plurality of text samples into a staging pipeline to generate a plurality of transformed samples having a standardized format compatible with the target operating system.

16. The system of claim 14, wherein the computer program instructions comprising transforming the plurality of text samples configure the one or more processors to:
execute a character normalization operation to replace non-alphanumeric characters with representations of a standardized format compatible with the target operating system.

17. The system of claim 14, wherein the computer program instructions comprising transforming the plurality of text samples configure the one or more processors to:
modify one or more reserved words and identifiers conflicting with the target operating system by adding at least one predefined escape character.

18. The system of claim 14, wherein the computer program instructions comprising transforming the plurality of text samples configure the one or more processors to:
modify a length of an identifier identified to exceed a predetermined length threshold for compatibility with one or more filesystem path length limitations of the target operating system.

19. The system of claim 14, wherein the computer program instructions comprising transforming the plurality of text samples configure the one or more processors to:
apply at least one of deterministic hashing or join matrices to convert one or more tokens of a text sample of the plurality of text samples into a unique numeric identifier.

20. One or more non-transitory computer-readable media storing computer program instructions that, when executed by one or more processors, effectuate operations comprising:
generating, from text data according to an order of the text data, a plurality of data samples, each data sample comprising a sequence of input tokens and a target token indicative of a class to which the sequence of input tokens belongs, each input token of the sequence of input tokens and the target token comprising an index mapped to a corresponding word in a vocabulary of words representing the text data;
converting the sequence of input tokens and the target token from the index to a corresponding word in the vocabulary to which the index is mapped, to generate a plurality of text samples;
transforming the plurality of text samples according to one or more characteristics of a target operating system operated by the one or more processors; and
generating a training data structure comprising a plurality of folders each representing a given target token of the plurality of text samples and being assigned each input token of the plurality of text samples that belongs to the class of the given target token.
